(19) United States
(12) Patent Application Publication
(10) Pub. No.: US 2003/0007758 A1
(43) Pub. Date: Jan. 9, 2003

(54) Precision fiber optic array connector and method of manufacture

(76) Inventors: Gary J. Rose, Boca Raton, FL (US); Dennis W. Davis, Eustis, FL (US)

Correspondence Address: MCHALE & SLAVIN, 4440 PGA BLVD, SUITE 402, PALM BEACH GARDENS, FL, 33410

(21) Appl. No.: 09/898,288

(22) Filed: Jul. 3, 2001

(51) Int. Cl. G02B 6/04; G02B 6/36

(52) U.S. Cl. 385/115; 385/137; 385/139

(57) ABSTRACT

A high precision fiber array connector and its cost-effective method of manufacture are disclosed. Extreme accuracy is achievable in a process for molding the connector faceplate. It is this faceplate which retains the fibers of the array at requisite lateral and angular tolerances. Additionally mechanical, magnetostatic, and electrostatic methods of fiber positioning and insertion into the connector faceplate are disclosed.

### FIELD OF THE INVENTION

This invention relates to optical fiber devices and more particularly to methods for aligning and fixturing an array of fiber ends in a connector geometry.

### BACKGROUND OF THE INVENTION

Telecommunication networks increasingly employ fiber optic systems instead of wire because of the significantly greater bandwidth achievable at a particular optical carrier wavelength. Additionally, optical wavelength division multiplexing offers even greater channel capacity. Inherent in any telecommunications network is the requirement for switching means that will allow routing of signals from disparate sources. Switching for voice channels and other telecommunications applications is typically conducted in a building that houses the switching hardware in a clean, well-controlled environment that allows repeatable switching without signal loss. In this environment, new switching technologies are coming on-line that will allow fast rerouting of light from one optical fiber to another. One such method based on micro-electromechanical systems (MEMs) uses tiny, independently-controllable mirrors to beamsteer light from the exit aperture of one fiber to the entrance of another. A more recent approach, still in the development stage, employs the electroholographic effect. This approach, pioneered by Trellis Photonics of Columbia, Md., involves writing a holographic Bragg grating into a photorefractive crystal (such as potassium lithium tantalum niobate—KLTN). Upon application of a voltage to the crystal, the grating appears and deflects an incident beam onto a new path. When the voltage is absent, the crystal is transparent and the light travels through undeflected. Switching times are on the order of 10 nanoseconds.

These methods are in contrast to current macro-mechanical positioning methods that are bulky and exhibit slow switching times. These new switching methods are implemented in very small geometries and require that the fibers of an array that is feeding the switch assembly be rendered in an extremely precise connector configuration. High density applications will require submicron accuracy in lateral fiber positioning and angular alignment of fibers to fractions of a milliradian. Total numbers of fibers in an associated bundle can approach several thousand.

Various means of creating perforated faceplates to contain a bundle of fibers in a regular geometry for the optical switching application have been addressed in the prior art. The challenge remains to find means for achieving the extremely tight tolerances required for compatibility with the new generation of switching technologies. The array connector concept developed by Fiberguide Industries addresses the problem of oversized guide holes contributing to positioning error. The approach used is to create conically-tipped fiber ends that are inserted into holes that are smaller in diameter than the fiber outer diameter. Then, the fiber tips protruding from the holes are polished flush with the guide surface. This method does not specifically address means to achieve fiber parallelism.

U.S. Pat. No. 5,185,846 assigned to AT&T introduces the use of a securing plate containing an array of precision holes and a guide plate having larger, conically-shaped holes for directing the fiber ends into the holes of the securing plate. A lateral fiber spacing accuracy of 2 microns is quoted in the specification. This was obtained by creating holes in silicon using lithographic means and etching along crystal planes. Fibers are introduced into the guide plate (and subsequently into the adjacent securing plate) a row at a time using a vacuum chuck to hold the fibers and an optical alignment scheme to insure nominal alignment of fiber ends with holes in the plate. Fibers are bonded into place with epoxy after proper placement. The issue of achieving a high degree of fiber parallelism is not specifically addressed.

### SUMMARY OF THE INVENTION

Precision alignment required in the precision optical connector application dictates use of a fixture concept that constrains the ends of the fibers to meet these stringent position tolerance requirements. The basic concept proposed herein devolves on creating an array of precision apertures in a substrate that will constrain the fiber ends. The manufacturing scheme for a connector of this type will involve fabrication of the fixture itself to requisite accuracy and implementation of a method or methods to introduce the fibers into the fixture for permanent placement.

Lateral positioning accuracy of the fibers will rely on the precision of hole size and placement in the substrate. Parallelism of the fibers will be controlled either by angularly constraining the fibers within channels of sufficient depth and tightness or by the combination of angular alignment of the fibers and bonding them into position.

The present invention discloses means for constraining the positions of the fiber ends in a large array of fibers to small lateral and angular position tolerances. Both the details of creating a fixture of accuracy requisite to achieving this goal, and the method of fiber insertion into such a fixture are described herein. The basic fiber fixture is a plate containing an array of regularly-spaced apertures. Each of these apertures will receive the end of a fiber and must meet the aforementioned lateral and angular position tolerances.

It has been determined that a micromachining method called LIGA can be adapted to provide molded versions of these tight tolerance, perforated plates. LIGA is the combination of a number of materials processing methods, namely, lithography, electroplating, and molding.

Closed-loop control of fiber insertion can be achieved using actuators to install fibers in the presence of microscopic imaging of fiber position. If the fiber array is a regular square or rectangular array comprising distinct rows of fibers, one prospect is the achievement of insertion of an entire row of fibers at the same time. In prior art methods, this has not been possible because of the tolerances associated with effectors holding the fibers, the location of the apertures and the six degrees-of-freedom associated with the geometry. The present invention discloses a fiber insertion process which is to some degree self-aligning. The free end of a fiber to be placed in a receiving aperture can be guided into position under electrostatic or magnetostatic force. The force fields created can serve to both attract the fiber into its destination position as well as provide restoring force to keep the fiber aligned upon insertion. If the fiber-guiding field, whether electric or magnetic, is made time varying, then braking forces can be applied in the insertion process. If the face of the plate containing the apertures is temporarily sealed with a thin, removable film, a fiber braking force can be effected by compression of air captivated in the channel as the fiber enters.

The following terminology is used in the specification and the claims. Definition of this terminology serves to clarify the invention as disclosed and claimed herein:

“Gray scale mask” refers to an x-ray absorbing mask which exhibits lateral gradients in the absorption of x-rays. Its use in the present invention is for production of tapered regions of the pins of the mold insert.

“LIGA” refers to a category of materials processing schemes that employ the combination of lithography, electroforming and molding in various ways.

“Mold insert” refers to a part that is used to replicate by molding means, the molded plate for fixturing optical fibers.

“Pin array” refers to an array of protrusions from a baseplate that provide for the creation of apertures in a molded plate for fixturing optical fibers.

“Resist” or “x-ray resist” refers to a material that is subject to chemical alteration by exposure to synchrotron radiation; the chemical alteration allowing chemical removal of such material that has been x-ray exposed.

It is an objective of the invention to provide a fiber array connector for optical fibers exhibiting tight positional tolerances.

It is another objective of the invention to provide a fiber array connector that is inexpensive to manufacture.

It is a further objective of the invention to provide a method of fiber array connector manufacture that can be

Other objectives and advantages of this invention will become apparent from the following description taken in conjunction with the accompanying drawings wherein are set forth, by way of illustration and example, certain embodiments of this invention. The drawings constitute a part of this specification and include exemplary embodiments of the present invention and illustrate various objects and features thereof.

### BRIEF DESCRIPTION OF THE FIGURES

FIG. 1 is a cross-sectional view of the fiber array connector of the present invention.

FIG. 2 is a pictorial diagram of the fiber connector plate.

FIG. 3 is a cross-sectional view of a prior art scheme for fiber alignment in an array connector.

FIG. 4a is a cross-sectional diagram of a perforated plate for constraining angular alignment of fibers.

FIG. 4b is a cross-sectional diagram of a stacked geometry comprising a number of fiber-receiving plates.

FIG. 5a is a cross-sectional diagram of a molded fiber receiving plate containing apertures with tapered entrances.

FIG. 5b is a cross-sectional diagram of a the molded fiber receiving plate depicting the adhesive bonding of inserted fibers.

FIG. 6a is a pictorial diagram of a mold insert for creating a fiber receiving plate with cylindrical channels.

FIG. 6b is a pictorial diagram of a mold insert for creating a fiber receiving plate with cylindrical channels having tapered ends.

FIG. 7a is a pictorial diagram of the irradiation step in the LIGA process for creating a polymer mold insert.

FIG. 7b is a pictorial diagram of the polymer mold insert created by LIGA.

FIG. 7c is a pictorial diagram of the polymer mold insert of FIG. 7b containing electrodeposited metal.

FIG. 7d is a pictorial diagram of the metal mold insert resulting from dissolution of the polymer mold insert of FIG. 7c.

FIG. 7e is a pictorial diagram of the infiltration of the metal mold insert of FIG. 7d with the molding material used to make a fiber receiving plate.

FIG. 7f is a pictorial diagram depicting the fiber receiving plate removed from the metal insert of FIG. 7e.

FIG. 8 is a schematic diagram of the process of synchrotron creation of x-rays used for LIGA resist exposure.

FIG. 9 is a cross-sectional diagram of the angular divergence of x-radiation at the plane of the LIGA resist.

FIG. 10. is a pictorial diagram of the shape of a mold insert pin having a taper at one end.

FIG. 11a is a pictorial diagram of the exposure of a cylindrical volume of LIGA resist determined by the x-ray mask geometry.

FIG. 11b is a pictorial diagram of the exposure of a conical volume of LIGA resist using a gray-scale x-ray mask.

FIG. 12 is a pictorial diagram of the mask and LIGA resist geometry for creating a cylindrical mold insert pin with a conical taper.

FIG. 13 is a cross-sectional diagram of a magnetostatic means of fiber alignment and insertion into a fiber receiving plate.

FIG. 14 is a cross-sectional diagram of an electrostatic means of fiber alignment and insertion into a fiber receiving plate.

### DETAILED DESCRIPTION OF THE INVENTION

Although the invention will be described in terms of a specific embodiment, it will be readily apparent to those skilled in this art that various modifications, rearrangements, and substitutions can be made without departing from the spirit of the invention. The scope of the invention is defined by the claims appended hereto.

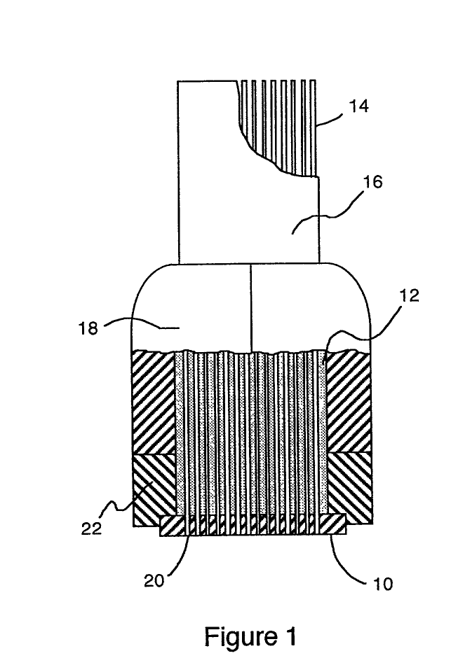

FIG. 1 is a cross-sectional view of the connector which is the subject of the present invention. Individual fibers 20 are shown in place within a fiber receiving faceplate 10. The fibers are embedded in an epoxy matrix 12 within the confines of an outer cylindrical housing 22. A cylindrical shell 18 is shown enclosing the assembly. The bundle 14 of fibers emanating from the connector are strain relieved by a semirigid sheath 16. The central inventive feature of this invention devolves on the form of fiber receiving faceplate 20. The details of its geometry, the method of its manufacture, and means for fiber insertion into this faceplate comprise the present invention.

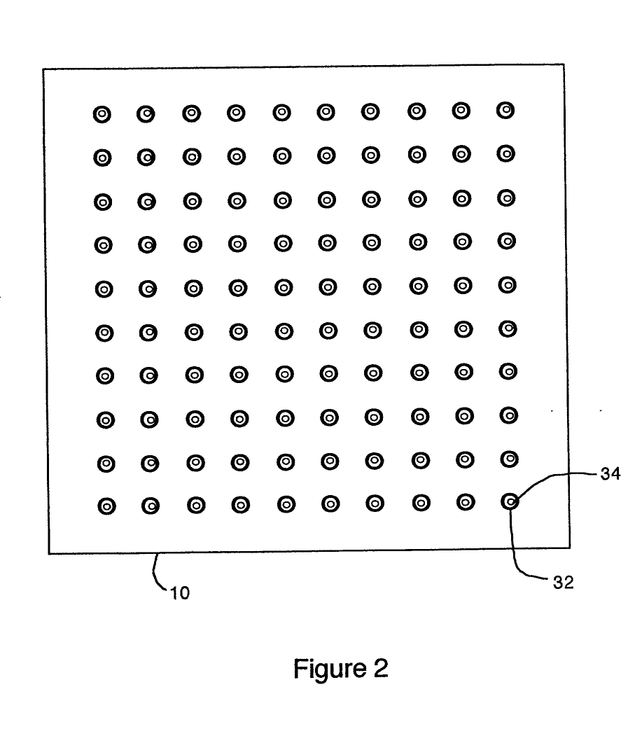

Reference is made to FIG. 2 which depicts the geometry of the faceplate 10 and the penetrating apertures. The circles 34 depict the precision cylindrical channels penetrating the depth of the face plate and the concentric larger circles 32 depict the tapered entrance to these channels.

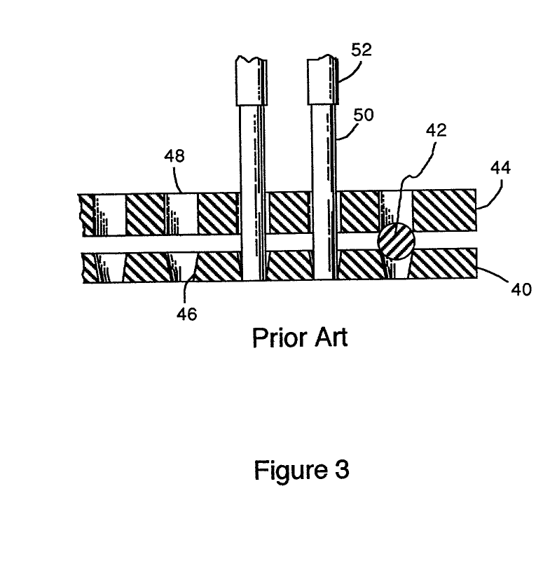

The present invention seeks to address the limitations of prior art methods in achieving high lateral and angular position control over the individual fibers fixtured by faceplates. FIG. 3 is a cross-sectional diagram depicting a prior art method of creating a faceplate using a guiding plate 44 having large apertures 48 and a securing plate 40 having smaller tapered apertures 46. Ends of the fibers 50 are shown inserted into the faceplate after removal of cladding 52. A spherical spacing element 42 for control of plate separation is shown. Significant difficulty is encountered in trying to align the disparate guiding and securing plates. Further, in this geometry there is lack of constraint on angular misalignment of fibers.

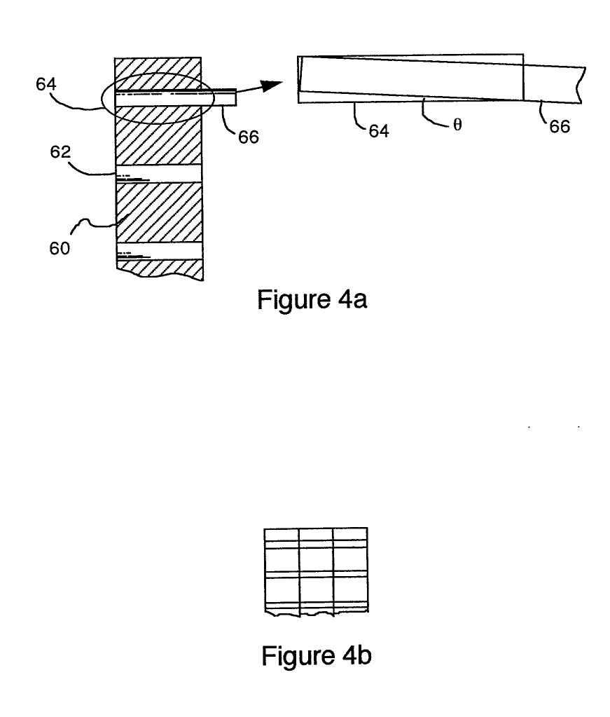

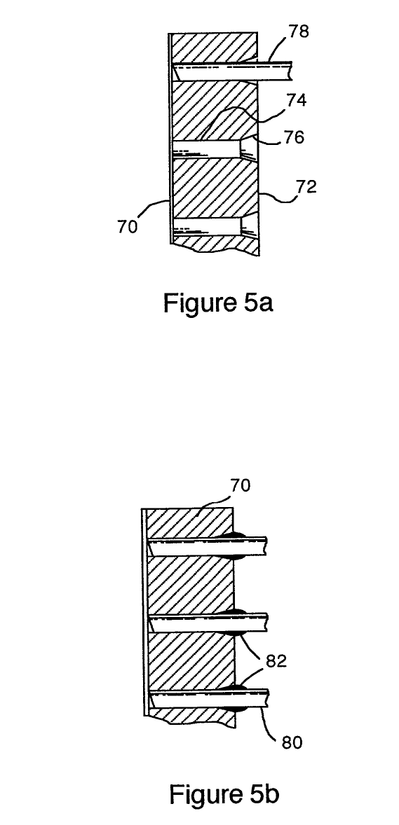

FIG. 4a depicts the means invoked in the present invention to achieve angular alignment of fibers. The figure is a cross-sectional diagram of a connector faceplate 60 showing a fiber end 66 inserted into a cylindrical channel 64 within the connector faceplate 60. The length of the channel 64 and its diameter relative to the diameter of fiber 66 establish the angular error. Achieving tight control of channel geometry in the present invention is by use of a precision molding approach. FIG. 4b depicts an embodiment of the present invention which makes use of a plurality of molded fiber receiving plates to achieve greater channel length and pronounced control over the angular error. FIG. 5a depicts a faceplate 72 with a channel geometry that eases insertion of fiber end 78 into cylindrical region 74 by means of a tapered entrance 76. Depicted is a 7 or 8 degree antireflection angle imparted to the fiber end prior to insertion and a temporary polymeric thin film 70 used to limit travel of the inserted fiber to the face of the faceplate 72. FIG. 5b depicts the permanent placement of fibers in the faceplate using an adhesive 82.

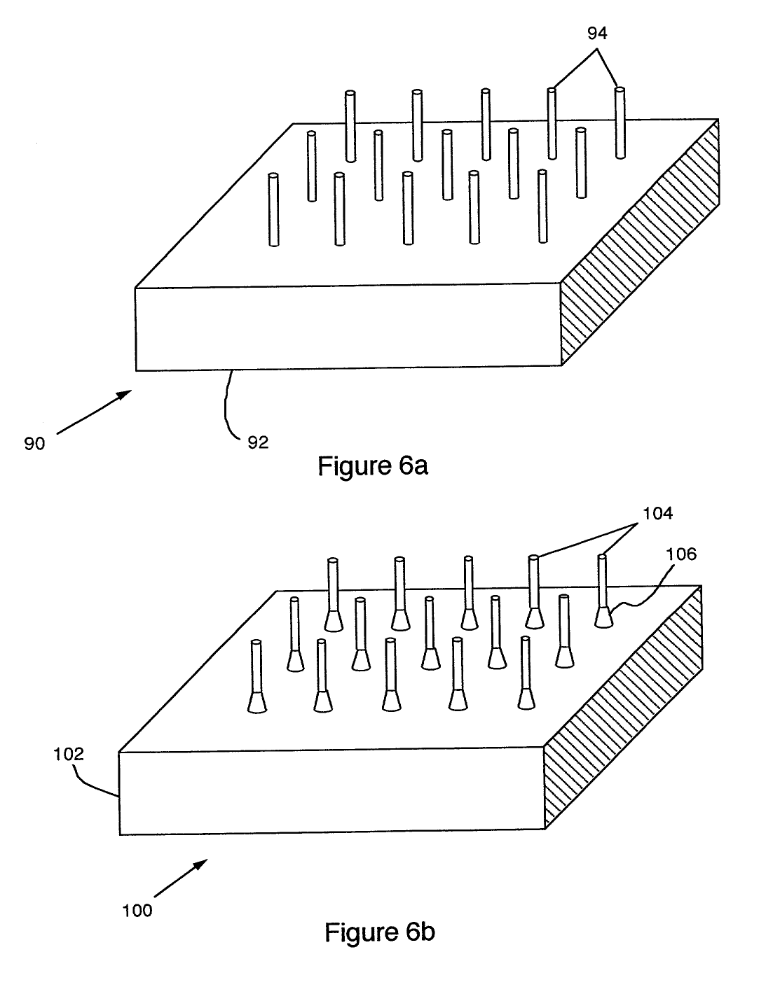

FIG. 6a depicts the geometry of a cylindrical pin array mold insert 90 having a base 92 and individual pins 94. The base 92 is of sufficient thickness to allow repeatable separation from the molded faceplate. An alternative geometry is provided in FIG. 6b in which mold insert 100 with base 102 displays individual cylindrical pins 104 having conical bases 106. This mold insert geometry gives rise to the preferred embodiment of the molded connector faceplate.

Fabrication

The connector fabrication process comprises two main aspects, manufacture of the faceplate fixture and accomplishing the introduction of fibers into this fixture. It is a goal of this invention to provide for the full automation of both aspects of the manufacturing process to thereby facilitate mass production of the connector.

Micromachining:

One of the critical fabrication issues is the creation of precision holes of small size. The current status of micromachining techniques provides for the feasibility of achieving the machining accuracy required.

Not more than fifteen years ago, precision, micron-sized pinholes for optical applications were foremost examples of precision micromachining. Such holes formed by laser ablation were not always tightly controlled in shape and could be placed only in very thin substrates. Today micromachining technology is an area of explosive growth that has its roots in semiconductor lithography but which encompasses a host of different machining techniques. Currently, much of this technology is being directed to the manufacture of microeletromechanical systems (MEMs) with characteristic dimensions typically in the tens of microns range. In some instances feature sizes as small as tens of nanometers have been achieved. Among the micromachining techniques available, LIGA (combination of lithography, electroplating, and molding) stands out as a preferred method because of the accuracy attainable and because it offers the prospect of a moldable product that can be mass-produced.

The faceplate holes to be produced in a typical current application are relatively high aspect ratio, 8:1 (1000 micron length, 125 micron diameter). There needs to be very little growth in hole diameter along its length. The holes should be parallel to the order of an arcsecond, and the circularity of the hole should be precise enough to accommodate only tolerance in the fiber cladding diameter. These requirements eliminate a number of methods due to physical infeasibility. Excimer lasers cannot maintain the required tolerance on hole diameter to a depth of 1 millimeter. Generally, etching techniques cannot achieve the tolerances required in lateral or depth dimension. Currently, microdrilling cannot achieve the required parallelism of the holes. Electrodischarge machining is a much less accurate methods than these others. Ion or electron beam milling may achieve the accuracies required, but would not be cost effective because of the extreme amount of time required to produce 1600 holes per connector. It is possible that iterative use of reactive ion etching (RIE) may be able to achieve hole geometries to the depth required. Also, the remaining contender, LIGA, touted as a preferred means of fabricating high aspect ratio structures, can achieve the accuracies required with some process tuning. Further, it offers the prospect of being able to mold these microstructures for mass production from a few precision mold inserts. The latter feature greatly favors LIGA over RIE. LIGA;

LIGA (Lithographie, Galvanoformung, and Abformung) is a method first developed in Germany which combines lithography, electroforming, and molding. Among the many micromachining technologies currently available, LIGA offers the ability to create large aspect ratio microstructures which exhibit extremely high spatial resolution and good edge parallelism.

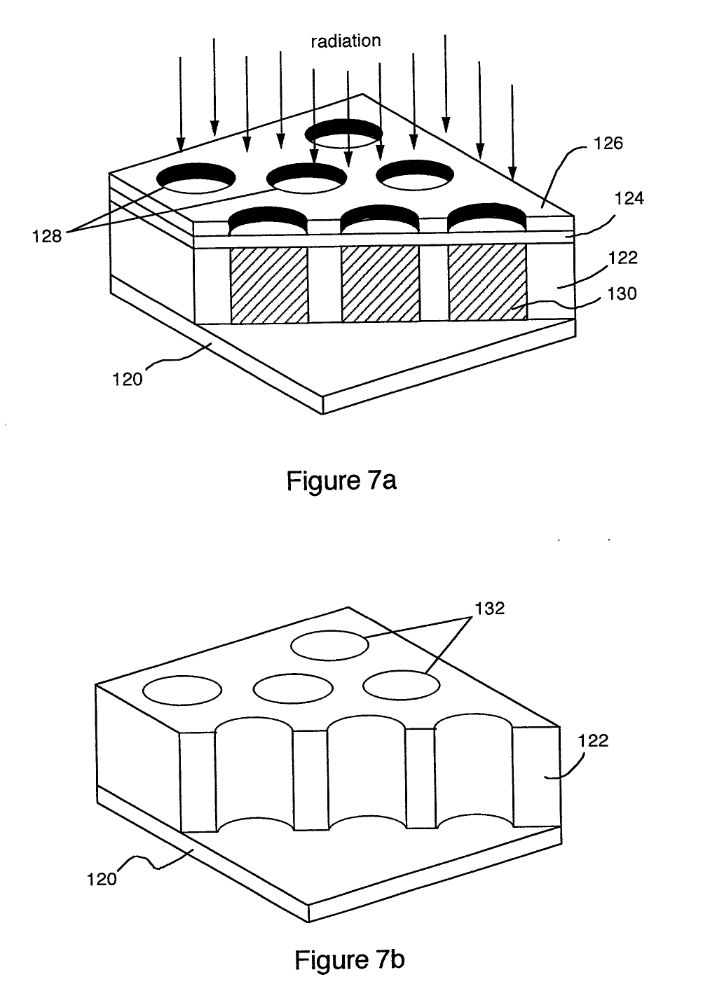

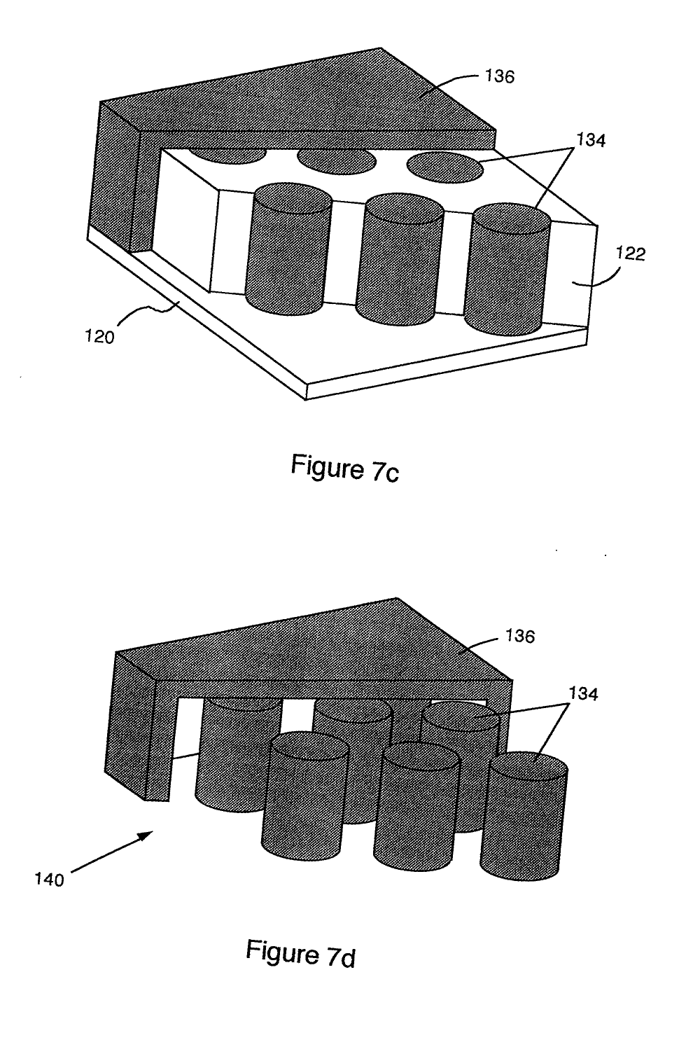

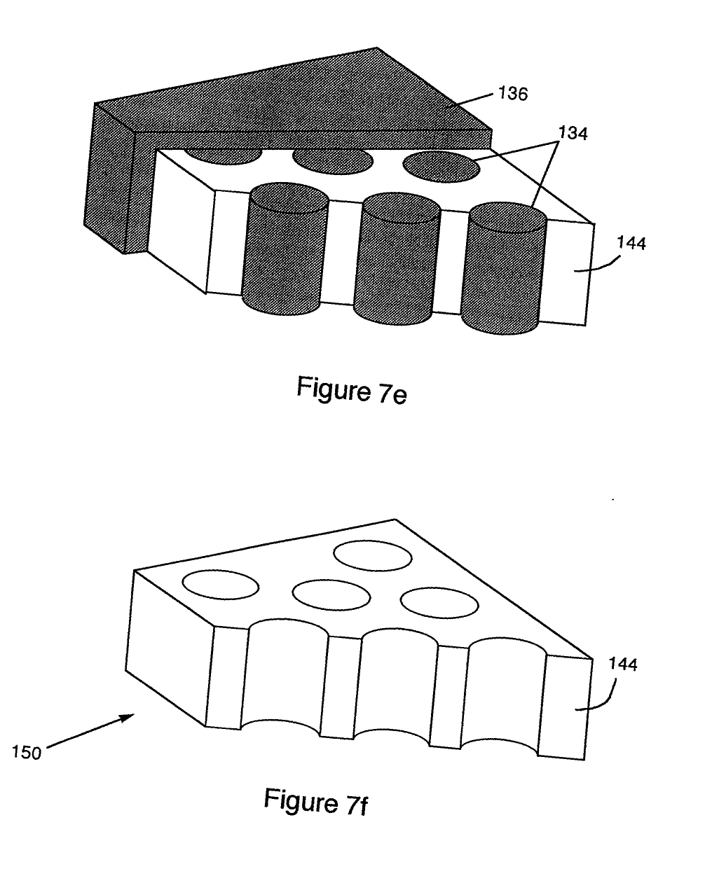

The process of fabricating a plate having apertures is depicted in FIGS. 7a through 7f. In FIG. 7a, an x-ray mask 126 having circular apertures or x-ray transparent regions 128 is placed over a resist substrate 122 with base 120 that is subsequently exposed to x-ray radiation from a synchrotron source. A common material used for resist is polymethylmetacrylate (PMMA). An optional standoff layer of material 124 is shown supporting the mask above the resist substrate 122. The irradiated portions 130 of the resist layer that were located under the x-ray-transparent regions of the mask are then dissolved away to yield a first mold made of the resist material as depicted in FIG. 7b. This first mold comprises hollow channels 132 formed in the resist 122 atop the base 120. The next step involves deposition of metal from an electrolyte, and a metallic structure being built up in the gaps of the resist structure until the metal layer is thick enough. This is shown in FIG. 7c where metal cylinders 134 fill previously void regions of the resist 122 and an overlayer 136 of metal has been electrodeposited. After removal of the resist, as depicted in FIG. 7d, a metal mold insert 140 is produced comprising the metal cylinders or pins 134 attached to metal base 136. This metal mold insert can be used repeatedly to replicate microstructures as shown in FIGS. 7e and 7f. In FIG. 7e, the material 144 such as polycarbonate or polyimide used to mold the connector faceplate is shown infiltrating the mold insert and surrounding pins 134. The molded part is released from the insert by mild heating and vertical separation using low force. After release of the mold insert, the finished connector faceplate 150 is as shown in FIG. 7f.

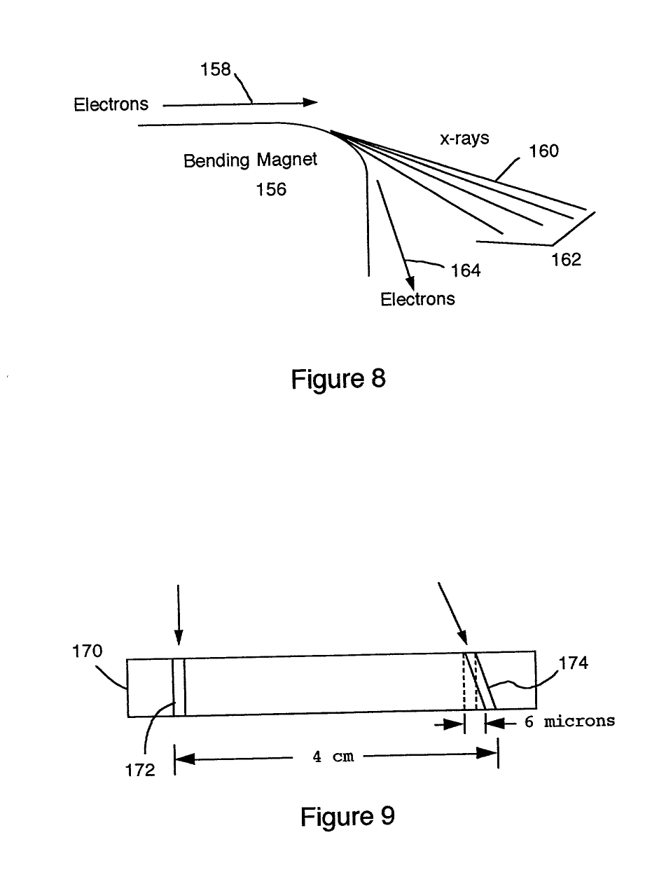

As mentioned, there are some process refinements necessary to allow a LIGA reduction to practice that achieves the fabrication goals set forth. There are thermal and mechanical stresses that occur during mask exposure that slightly modify the geometry of the mask. Hence it is necessary for iterative production of the optical and corresponding x-ray mask in order to render a hole diameter of correct size in the exposed resist structure. Further, to maintain hole diameter and placement accuracy over the full 4 cm field, a titanium x-ray mask can be used that will be spatially invariant to environmental influences. FIG. 8 depicts the magnetic bending of an electron beam path 158 to a new path 164 and the attending creation of a divergent beam 160 of x-rays generated in a synchrotron source. The impact of this beam spread 162 on the exposure of the resist structure under the x-ray mask is shown in FIG. 9. In a single exposure of the mask and underlying resist material 170, the angular dispersion of the beam would cause a differential angle of 6 milliradians between the holes 172 and 174 at the opposite ends of the geometry. This is a factor of 10 times greater than that required to meet submilliradian departure from parallelism. It has been determined that this problem can be overcome by exposing the 4 cm width of the substrate with 8 successive local exposures using the most vertical portion of the x-ray beam.

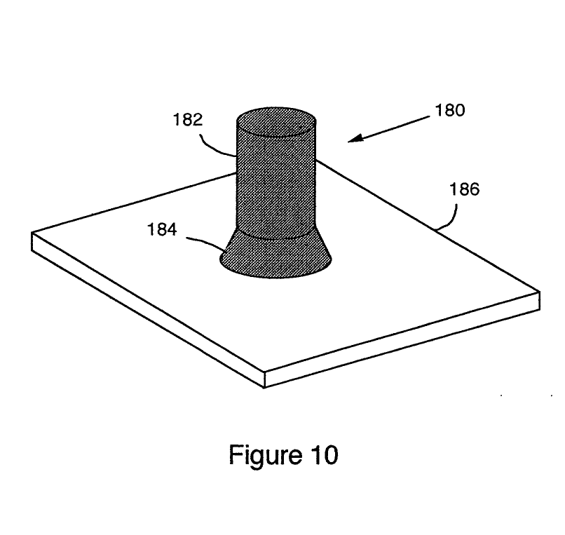

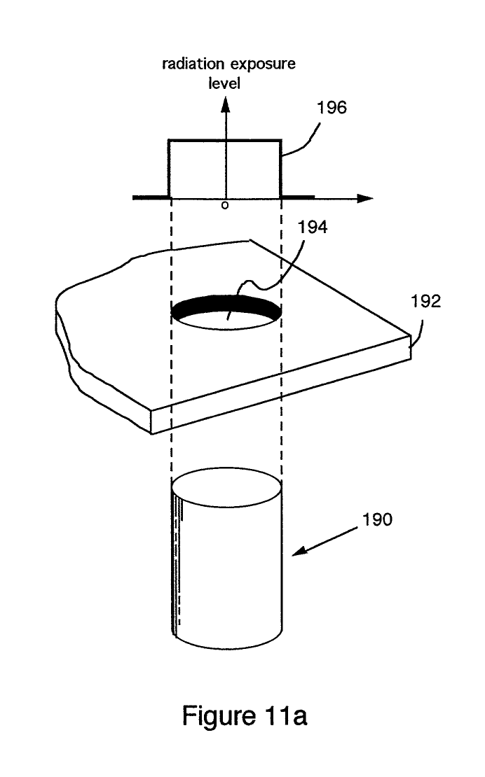

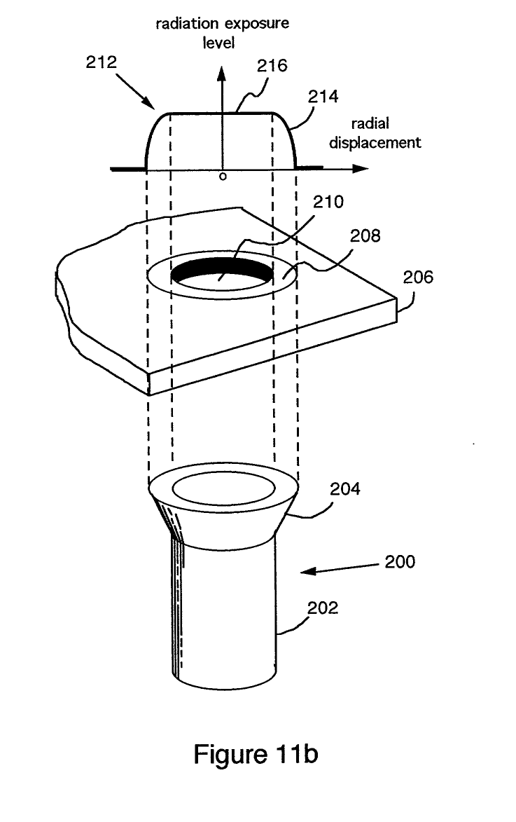

Foremost among benefits achievable by manipulation of the mask technology is the ability to create the preferred geometry 180 for the pins of the mold insert. This geometry is shown in FIG. 10, a cylinder 182 resting on a truncated cone 184. FIG. 11 depicts how this geometry is achieved by use of LIGA masks. In FIG. 11a, an x-ray mask 192 is shown with a circular transparent region 194 which allows a uniform radiation exposure 196 to a cylindrical volume 190. FIG. 11b depicts how the conical shoulder to the cylinder can be created. The x-ray mask 206 is shown with a circular transparent region 210 concentric with a larger gray scale absorbing annulus region 208. The radiation exposure curve 212 shows the uniform exposure 216 of the cylindrical volume and a tapered exposure 214 to the conical shoulder region. The uniform and tapered exposures can be achieved by masking and exposure on the same side of the resist or by using a uniform mask with exposure on one face of the resist and using a gray scale mask and associated exposure on the opposing face of the resist.

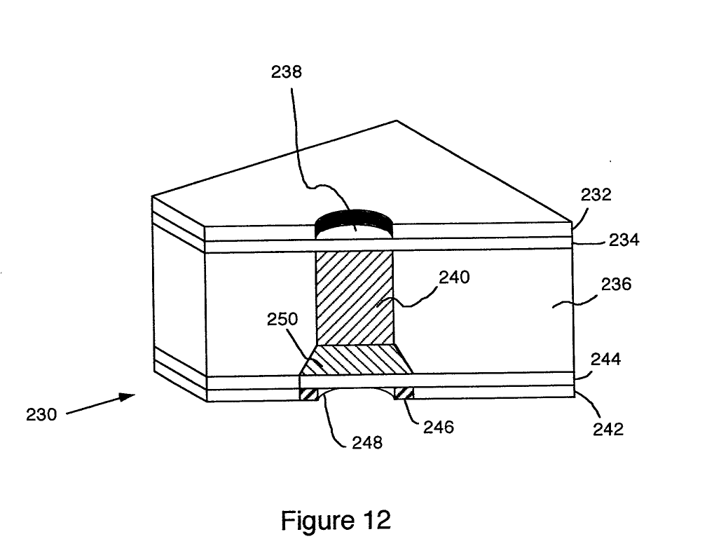

FIG. 12 depicts the use of the uniform mask 232 and gray scale mask 242 on opposing faces of the resist material 236. There can be some advantage to this approach in terms of accuracy. Shown is the region 240 that sustains uniform exposure from above as radiation transits transparent aperture 238. Region 250 sustains gradient exposure from below as radiation exposure is graded radially by gray scale mask 246.

The thickness of the faceplate is limited by the accuracy that LIGA can achieve in thick exposures. For the present connector application, tolerances can be maintained to thicknesses of a millimeter. Hence, it is imperative that either the faceplate exhibit stiffness to maintain angular parallelism of fibers or that it is mounted on a secondary substrate or stiffener for this purpose. Because the polymer faceplate ultimately becomes part of a larger assembly, the larger assembly can serve to support the plate and maintain the desired geometry. One approach to limiting flexion of the faceplate is to create a stack of polymer plates and bond them together to achieve a composite thickness of several millimeters. Certainly the use of appropriate filled polymers is a viable scheme for achieving improved stiffness of a millimeter thick faceplate. Another approach is to use composites as the material of choice. A promising new set of composites comprise nanocomposites. These are particulates of materials species only a few nanometers in diameter. Many candidate materials of this type are available and discussed in the work of A. M. Morales, M. Gonzales, and J. M. Hruby, “Nanocomposites: New Building Blocks for MEMs,” 7th Foresight Conference on Molecular Nanotechnology, Sandia National Laboratories, Livermore, Calif. Alternatively, the polymer plate can be bonded to a metal backing plate with larger holes concentric with the holes in the polymer plate.

Optical Mask Fabrication

An optical mask is needed to transfer the desired pattern on to an x-ray mask and ultimately onto the metal substrate to produce the molding tool. This is a well developed technology without any factors that would contribute to dilution of precision in the final part.

X-ray Mask Fabrication

There are a number of different types of x-ray masks. Among them are gold on polyimid, gold on graphite, and gold directly on substrate. Below is a discussion of advantages and disadvantages of each mask:

Gold Directly on Substrate

This involves placing the gold for absorbing x-rays directly on a PMMA substrate which is to be exposed. A piece of 1 millimeter thick PMMA is bonded to the surface of the substrate that is to be used for the insert. To the bonded PMMA, a plating base is thermally deposited. Next, a photo resist is spun and the photo resist is patterned with the optical mask. The final step is to electroplate the gold absorber. The transfer is one-to-one so, theoretically, all of the center-to-center spacing tolerances of the hole pattern should transfer. Experimentally, however, the uniformity of the resist layer, sidewall losses from the developing process and the quality of contact obtained when doing the UV lithography with the optical mask defines the tolerances that will be achieved. The major disadvantages of this technique are (1) the lithography processing must be done on every attempt and (2) plating base adherence does not always occur. The biggest advantage is that the tolerances should be better than the other possibilities. This method provides the most parallel posts on the metal insert because the space between mask and substrate is non-existent.

Gold on Polyimid

This method involves stretching a 25-micron thick polyimid film and doing the lithography and gold electroplating on the film itself. This method is easy to implement, but requires precise characterization of the masks and the effects caused by exposure to x-rays.

Gold on Graphite

This method runs a close second to the first method mentioned above. The graphite is very rigid holds up very well under exposure conditions. As in the other methods, the lithography and electroplating of the gold absorber is done the same way but on a 125 or 250-micron graphite substrate.

In addition to the previously stated methods, a variety of other x-ray mask fabrication processes exist, such as gold on Si, and gold on Ti. These methods are also considered within the scope of the present invention.

X-ray Exposure and Development of Resist

PMMA is the most common x-ray resist used today. Although insensitive to x-rays and hence requiring high doses, PMMA gives excellent features and develops relatively easy. The resist has a slope of 1/1000, and can be in the positive or negative direction depending on whether a direct plating process or an over-plating process is used to create the metal structures. The over-plating process is a preferred method to create the metal tool, which will result in the radius of the top of the post being 1 μm smaller then the radius of the base. The diameter of the top post will be able to be controlled to within +/−0.5 μm. This can be accomplished by performing a few (2-3) iterations to achieve such a tight tolerance. Each iteration will require the complete process to be performed again, starting from the optical mask, which will be adjusted for the amount of the loss or gain observed in the developed PMMA.

Thermal expansion is also an important issue that must be dealt with in order to achieve the required tolerances. The thermal expansion coefficient of PMMA is (70 to 77×10-6)/degree Kelvin and the thermal expansion coefficient of the substrate is between (9 to 16×10-6)/degree Kelvin depending on which substrate is used. Hence, a 40 mm piece of free PMMA will expand 1 μm for every 0.36 degree Kelvin rise in temperature. However, the PMMA will be bound to a metal substrate decreasing the amount of expansion to around 1 μm for every 3 degree Kelvin rise in temperature. Therefore, the expansion of the bonded PMMA will be substantially less than that of the free PMMA. The temperature can be controlled to within 1 to 2 degrees Kelvin by both blowing helium onto the PMMA during exposure and reducing the relative time the features are actually being exposed. Performance can be tuned by predictive assessment using finite element analysis.

Electroplating

Typically, nickel is used to create a mold insert, but because the plating temperature of a nickel bath is 55 degrees Kelvin, the deformation due to thermal expansion tends to be too high. A copper plating bath can be used to form the metal structures at 25 degrees Kelvin. The material properties of copper are not quite as good as nickel, but the copper molding tool created will still be sufficient to mold most thermal plastics.

Fiber Micropositioning

Micropositioning stages are available which are capable of motion step sizes in the 10 nanometer range. Linear translation stages can be used to introduce fibers into the securing plate holes a row at a time. Local translation is required for alignment of fibers at each row. Subsequently with the dispensing of a new row of fibers for insertion, the stage must be advanced in a direction to place the new set of fibers at the next row position. Microscope imaging means with automation software can be used for closed-loop control in aligning the fibers with the holes. Open-loop control of insertion of the fibers into the holes is possible using the encoder information from the motors of the translation stage. Dispensing of a complete row of fibers for insertion can be accomplished using a vacuum chuck array as in U.S. Pat. No. 5,185,846 or by use of sleeve structures that feed the fibers into the row geometry. Should the need arise, six degree-of-freedom stages such as manufactured by Newport Corporation for applications such as fiber optic alignment can be used for this application.

Magnetic Positioning

One concept for improving the ease of fiber alignment with the securing plate holes is to use magnetic control of fiber position. Two instances of prior art use magnetic coatings of optical fiber to control spool payout and to secure fibers in a fixed position, respectively. The coating of spooled optical fiber with a ferromagnetic coating such as nickel is disclosed in U.S. Pat. No. 5,276,846. When the spool is exposed to a magnetic field of controlled intensity, the fibers adhere to one another magnetically. Since the strength of adhesion is governed by the field strength, adjustment of the field strength allows control of the unspooling tension of the fiber. U.S. Pat. No. 5,213,212 discloses the use of magnetic coatings on optical fibers so that they can be held in place by a magnetic field.

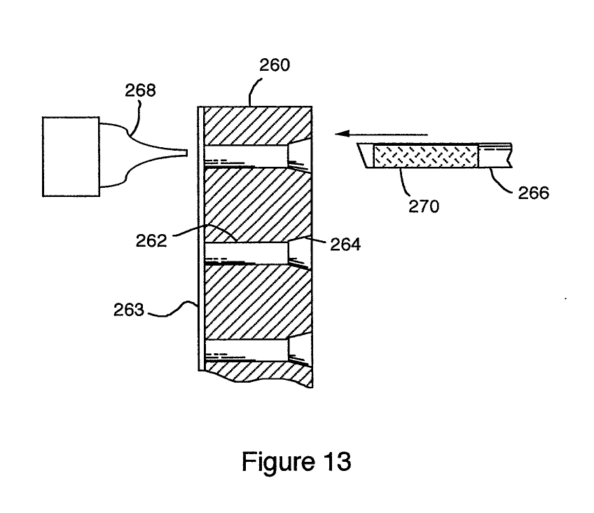

These patents are the inspiration for the present concept of magnetically guiding the fibers into holes in the securing plate 260, as depicted in FIG. 13. The end 266 of the fibers can be coated with nickel 270 prior to face polishing (as in the latter patent), so that it will exhibit induced magnetism under influence of an applied magnetic field. A permanent-magnetic coating can be used as well. If the coating thickness required for sufficient attractive force is too great for insertion of the 1 millimeter end of the fiber into the guide plate, the coating can be applied to the fiber at a distance greater than 1 millimeter from the fiber's polished end. When a fiber is sufficiently close to the tapered portion 264 of a hole, energizing a magnetic field in the proximity of the hole can attract the fiber into the position-constraining portion 262 of the hole. Sufficient flux density must be present in the proximity of the hole. This can be achieved by using high permeability flux condensing material as is used in magnetic field sensors. A flux condensing probe 268 as shown in the figure, can be contoured appropriately. Removable polymeric film 263 serves to prevent excess translation of the fiber under the force of the magnetic field. An example of such flux condensation in an integrated circuit sensor is provided in U.S. Pat. No. 5,883,567. If a whole row of 40 fibers is to be introduced concurrently into a corresponding row of 40 holes, an array of flux condensing probes can be energized adjacent the securing plate. Sufficient field gradients must exist to cause each fiber to seek its designated hole and not be attracted to an inappropriate hole. An example of the type of magnetic microactuation proposed herein is provided in U.S. Pat. No. 6,146,103 which describes the micromachining of magnetohydrodynamic (MHD) actuators and sensors.

Electrostatic Positioning

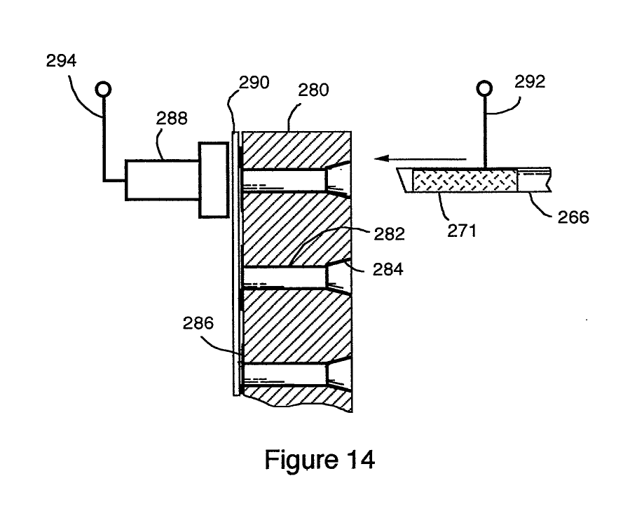

Electrostatic positioning is an alternative to magnetic positioning that requires less in the way of fiber coating thickness. In the magnetic case, the coating thickness is related to the magnetic force attainable, whereas in the electric case, the coating thickness is unrelated to the achievable magnitude of electric force. The area of the coating will provide enough capacitance that large amounts of charge can be deposited on the fiber end to support a large voltage difference and hence large attractive electric field strength. As shown in FIG. 14, faceplate 280 having faceplate holes 282 is shown with a thin metallic coating 284 on the surface of the holes and around the distal end of each such hole. This is achievable by masking and vapor deposition methods well known in the semiconductor and coatings industries. A microelectrode 288 having a first polarity lead 294 is brought into contact with the conductive hole. Voltage lead 292 of an opposing polarity is brought into contact with the fiber 266 having a metal coating 271. As a fiber is brought into gross proximity of its respective hole, there will be a centering, attractive force due to the local electric field established between the fiber and the hole. Removable polymeric film 290 serves to prevent excess translation of the fiber under the force of the electric field. As in the case of magnetic positioning, the geometry of the electric field strength map can be influenced by use of high permittivity materials. A guide plate, not shown in the figure, may be included in this scheme.

While there have been shown and described the preferred embodiments of the present invention, it is to be understood that the invention can be embodied otherwise than is herein specifically illustrated and described and that, within such embodiments certain changes in the detail of construction or method of manufacture, and in the form and arrangements of the components of this invention, can be made without departing from the underlying idea or principles of this invention within the scope of the appended claims.

We claim:

1. An optical fiber fixture comprising:
a plurality of optical fibers; and a planar substrate containing an array of apertures; wherein each of said optical fibers having an end portion extending through said planar substrate and affixed thereto, said optical fibers maintained in relative angular alignment by the diameter of said apertures.

2. An optical fiber fixture as recited in claim 1 wherein each said aperture comprises a proximal tapered guiding portion and a distal cylindrical portion, said proximal portion serving to facilitate introduction of a free end of each said fiber into a respective said aperture and the diameter of said cylindrical portion establishing said relative angular alignment of said fibers.

3. An optical fiber fixture as recited in claim 2 which is produced by injection molding.

4. An optical fiber fixture as recited in claim 2 wherein said planar substrate is produced from material selected from the group comprising polymers, ceramics, and composites.

5. An optical fiber fixture as recited in claim 2 wherein said plurality of fibers are arranged in a regular array of rows of fibers, each said row of fibers containing a fiber free end portion and a bonded ribbon portion, said free end portions inserted into said apertures.

6. An optical fiber fixture as recited in claim 2, wherein said free end portions of said fibers are coated with a magnetic material, said magnetic material serving to permit magnetic force insertion of said free end portions of said fibers into said apertures.

7. An optical fiber fixture as recited in claim 2 wherein said free end portions of said fibers are coated with a conductive material, said conductive material serving to store electric charge and permit electric force insertion of said free end portions of said fibers into said apertures.

8. A method for fabricating an optical fiber fixture comprising the steps of:
forming a pin-array mold insert using a LIGA process;
molding a plate having an array of apertures using said pin-array mold insert;
inserting each end of a plurality of optical fibers into each of said apertures; respectively, and
adhering each said fiber upon positioning of said fiber within said aperture.

9. A method for fabricating an optical fiber fixture as recited in claim 8 wherein said step of forming a pin-array mold insert further comprises the steps of:
forming an aperture array x-ray mask;
placing said x-ray mask over an x-ray resist substrate;
exposing the combination of said x-ray mask and said resist to synchrotron radiation;
removing x-ray-exposed resist from said resist substrate;
electrodepositing metal into voids formed by said removal of x-ray-exposed resist; and
removing said resist surrounding said electodeposited metal to provide a metal mold insert in the form of said pin-array.

10. A method for fabricating an optical fiber fixture as recited in claim 8 wherein said step of forming a pin-array mold insert further comprises the steps of:
forming an aperture array x-ray mask wherein each said aperture comprises a transparent circular region and a concentric gray-scale, absorbing annular region;
placing said x-ray mask over an x-ray resist substrate;
exposing the combination of said x-ray mask and said resist to synchrotron radiation;
removing x-ray-exposed resist from said resist substrate;
electrodepositing metal into voids formed by said removal of x-ray-exposed resist, and
removing said resist surrounding said electodeposited metal to provide a metal mold insert in the form of said pin-array, each said pin comprising a cylindrical portion and a tapered portion.

11. A method for fabricating an optical fiber fixture as recited in claim 8 wherein said step of forming a pin-array mold insert further comprises the steps of:
forming a first aperture array x-ray mask wherein each said aperture comprises a transparent circular region;
placing said first x-ray mask over a first face of an x-ray resist substrate;
exposing the combination of said first x-ray mask and said resist to synchrotron radiation;
forming a second aperture array x-ray mask wherein each said aperture comprises a gray-scale, absorbing annular region that is laterally aligned to be concentric with a respective said aperture in said first x-ray mask;
placing said second x-ray mask over a second opposing face of said x-ray resist substrate with the centers of said apertures of said second x-ray mask in lateral alignment with the respective centers of said apertures of said first x-ray mask;
exposing the combination of said second x-ray mask and said resist to synchrotron radiation;
removing x-ray-exposed resist from said resist substrate;
electrodepositing metal into voids formed by said removal of x-ray-exposed resist, and
removing said resist surrounding said electodeposited metal to provide a metal mold insert in the form of said pin-array, each said pin comprising a cylindrical portion and a tapered portion.

12. A method for fabricating an optical fiber fixture as recited in claim 8 wherein said step of inserting further comprises the steps of:
coating each free end of said optical fibers with a magnetic coating;
establishing a magnetic field to attract each said magnetically-coated fiber end into a said aperture; and
positioning each said fiber within each said aperture by said magnetic field.

13. A method for fabricating an optical fiber fixture as recited in claim 8 wherein said step of inserting further comprises the steps of:
coating each free end of said optical fibers with a metallic coating;
establishing an electric field to attract each said metal-coated fiber end into a said aperture, and
positioning each said fiber within each said aperture by said electric field.

14. A method for fabricating an optical fiber fixture as recited in claim 8 wherein said step of inserting further comprises the steps of:
placing a polymeric film on the distal face of said plate;
inserting each free end of said optical fibers into a respective said aperture until contact with said polymeric film, and
removing said polymeric film subsequent to said adhering of said fibers.
